(19) United States
(12) Patent Application Publication
(10) Pub. No.: US 2004/0222316 A1
(43) Pub. Date: Nov. 11, 2004

(54) Application of hair treatments and other formulations

(76) Inventor: Steve Scholz, Houston, TX (US)

Correspondence Address: Mark A. Oathout, 3730 Kirby Drive, Suite 830, Houston, TX, 77098, US

(21) Appl. No.: 10/485,623

(22) PCT Filed: Jul. 30, 2002
(86) PCT No.: PCT/US02/24239

Related U.S. Application Data
(60) Provisional application No. 60/308,917, filed on Jul. 31, 2001.

(51) Int. Cl. B05B 7/30

(52) U.S. Cl. 239/318

(57) ABSTRACT

An entraining device in the nature of a paint gun receives pressurized air, which entrains a hair treatment formulation into the stream of pressurized air. This mixture is fed to an applicator such as a brush. Once the mixture is fed onto the bristles of the brush, an operator can apply it to color, highlight, or tint hair. The hair treatment formulation may be supplied by a storage chamber which is part of or connected to the entraining device. The system could also be used for applying various treatments to the skin or to other mammals.

### CROSS-REFERENCE TO RELATED APPLICATIONS

This application is the National Stage of International Application No. PCT/US02/24239 filed Jul. 30, 2002 which claims the benefit Under 35 USC 119(e) of U.S. Provisional Application No. 60/308,917 filed Jul. 31, 2001.

### STATEMENTS REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

Hair treatments such as coloring, tinting, or highlighting are normally applied by mixing a composition of a hair treatment formulation and an activator in a bowl. Next, a technician dips a brush into a bowl. Then, the composition is brushed onto a customer's hair. After the composition on the brush is spent, the technician must repeat the steps of dipping the brush and applying the composition.

In the typical situation, a technician will book about a one hour block of time for a customer. About thirty minutes is needed for completing the steps mentioned in the preceding paragraph, and about thirty minutes is needed for processing the customer after the treatment is applied.

The technician is compensated for performing a service. Therefore, their income is largely determined by the service performed, the amount they can charge for the service and the volume of services they can perform in a given frame of time. For example, if a technician planned to book only hair coloring appointments on a certain day, they would probably be able to book and treat six to eight customers during normal business hours.

### BRIEF SUMMARY OF THE INVENTION

An entraining device in the nature of a paint gun receives pressurized air, which entrains a hair treatment formulation into the stream of pressurized air. This mixture is fed to an applicator such as a brush. Once the mixture is fed onto the bristles of the brush, an operator can apply it to color, highlight, or tint hair. The hair treatment formulation may be supplied by a storage chamber which is part of or connected to the entraining device. The system could also be used for applying various treatments to the skin or to other mammals.

Certain embodiments of this invention are not limited to any particular individual features disclosed, but include combinations of features distinguished from the prior art in their structures and functions. Features of the invention have been described so that the detailed descriptions that follow may be better understood, and in order that the contributions of this invention to the arts may be better appreciated. These may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. This invention is to be read to include any legally equivalent devices or methods which do not depart from the spirit and scope of the present invention.

The present invention recognizes, addresses and meets its preferences or objectives in its various possible embodiments and equivalents thereof. To one of skill in this art that has the benefit of this invention's realizations, teachings, disclosures, and suggestions, other purposes and advantages will be appreciated from the following description and the accompanying drawings. The detail in the description is not intended to thwart this patent's object to claim this invention no matter how others may later disguise it by variations in form or additions of further improvements. These descriptions illustrate certain preferred embodiments and are not to be used to improperly limit the scope of the invention, which may have other equally effective or legally equivalent embodiments.

### BRIEF DESCRIPTION OF THE SEVERAL VIEWS OF THE DRAWINGS

FIG. 1 is a perspective view of one embodiment.

FIG. 2 is an elevational view of an entraining device with a storage chamber mounted thereon.

FIG. 3 is a schematic view of a package of treatment formulation.

FIG. 4 is a perspective view of an applicator in the form of a brush.

FIG. 5 is a pneumatic diagram for one embodiment of the invention.

### DETAILED DESCRIPTION

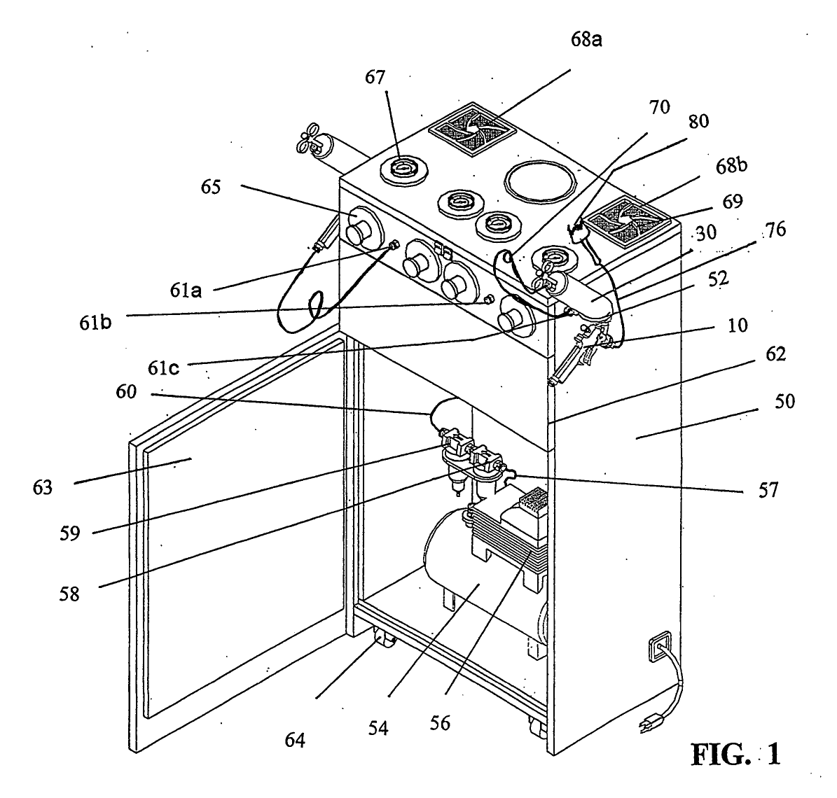

Referring to FIG. 1, generally, in one embodiment of the invention, an entraining device 10 has a storage chamber 30 connected on top of the entraining device 10. Both are shown mounted on a rack 52 which is attached to an enclosure 50. The enclosure 50 houses a compressor 54. Tube 70 supplies pressurized air from the compressor 54 to the storage chamber 30. Tube 72 supplies pressurized air from the compressor 54 to the entraining device 10. Tube 76 runs from the entraining device 10 to an applicator 80.

The enclosure 50, as mentioned, contains a device for supplying pressurized air 53 such as a compressor 54. The compressor 54 may be powered by a motor 56. Air from the compressor 54 may be fed through a tube 57 to filters 58, 59, such as coal filters for removing moisture, etc. from the air. From the filters 58, 59, a tube 60 conducts pressurized air to typical splitter(s) (not shown) for feed to respective outlet ports (three of four shown) 61a, b & c from the enclosure 50. The door 62 allows access to a storage compartment in the enclosure 50. Door 63 allows access to the compressor 54, motor 56, filters 58, 59, etc. Swivel type wheels 64 may be connected below the enclosure for mobility. Regulators with controllers 65 are connected to each supply line 66. Pressure gauges 67 are connected to same. Vents 68a & b are mounted on the enclosure 50 for moving and filtering the air in the immediate vicinity. This is useful for removing enamels and ammonia, for example, which are created by chemicals used in the hair treatments. Each vent 68a,b may include a fan/blower, filter (such as carbon impregnated filter) 69, motor and a computer controller.

The enclosure 50, in one embodiment, feeds air to the entraining device 10 at about twenty-five psi, and feeds air to the storage chamber 30 at about thirty psi. The enclosure 50 provides a noise reducing structure to surround the compressor 54 and motor 56 and may include additional lining for such purpose.

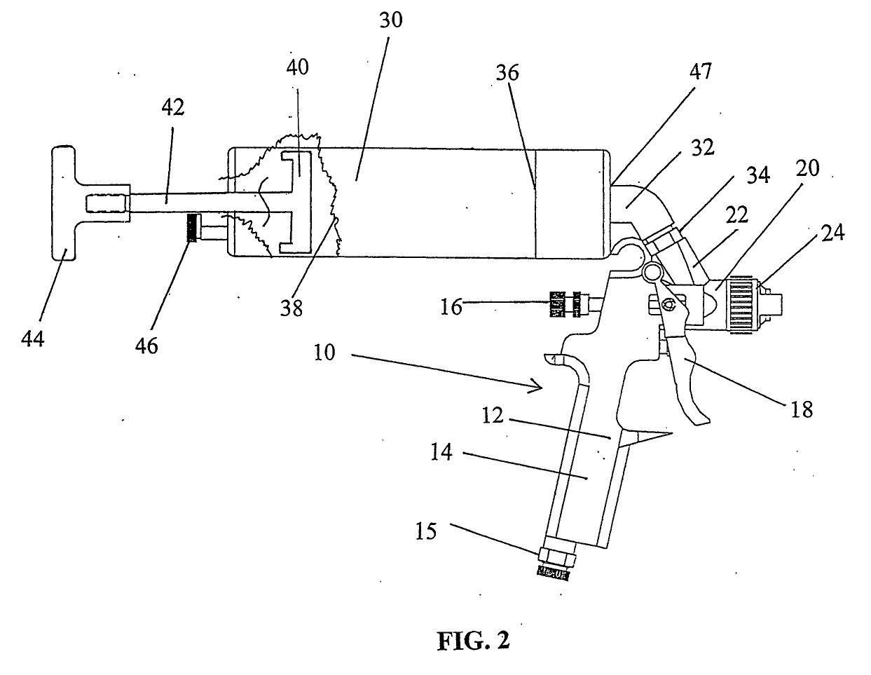

Referring to FIG. 2, the entraining device 10 may be a paint gun 12. A paint gun 12 commercially available from HVLP may be used in the embodiment shown. The entraining device 10 includes a handle 14, a valve 16, a lever 18 for operating the valve 16 and a mixing chamber 20. The lower end of the handle 14 has an inlet port 15 for connection to tube 72. The inside of the handle 14 and the mixing chamber 20 define a primary flow passage through the entraining device 10. A second flow passage defined by the treatment inlet 22 and the mixing chamber 20 intersects the primary flow passage in the mixing chamber 20. The lever 18 and valve 16 may be used to selectively open and close both the primary and the secondary flow passages. The mixing chamber 20 feeds to a nozzle 24. The nozzle 24, in the present embodiment, delivers a mixture of the air and the hair treatment formulation at about forty-five psi to a brush 81. However, the nozzle 24 could be an adjustable spray nozzle and function as the applicator 80 in which case a spray pattern having a width varying from about 1/4 inch to three inches is preferred. The entraining device 10 can also include air flow or chemical flow adjusters built into the device (devices other than the lever 18).

The storage chamber 30 is connected to the treatment inlet 22 by an elbow fitting 32 and a converter plug 34. The storage chamber 30 has a cap 36 attached to a cylinder 38. Together, the cap 36 and cylinder 38 define a hollow interior for holding a supply of the composition/hair treatment formulation. A plunger 40 may be used to compress and/or open a container of treatment formulation contained within the storage chamber 30. A gas/fluid inlet 46 connects the interior of the storage chamber to tube 70 allowing entry of pressurized air to force the plunger 40 against the treatment formulation to outlet 47 and further to the treatment inlet 22 of the entraining device 10. The plunger 40 may be retracted via the rod 42 and handle 44.

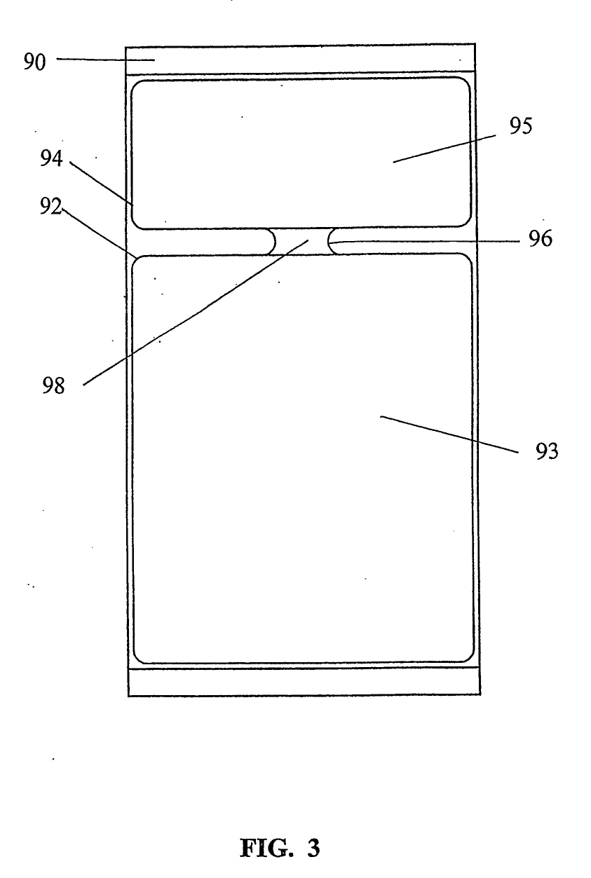

FIG. 3 is a schematic view of a package 90 of treatment formulation which may for example hold about eight ounces of formulation. A first sealed pouch 92 contains a volume of hair treatment formulation 93. A second sealed pouch 94 contains a volume of an activator 95 for the hair treatment formulation 93. The package or third sealed pouch 90 contains both the first sealed pouch 92 and the second sealed pouch 94. The first sealed pouch 92 and the second sealed pouch 94 are joined by a conduit 96 with septum 98. The septum 98 may be easily ruptured by any commonly known manner. Thus, when the treatment formulation is needed, the second pouch 94 may be squeezed to break the septum 98. Next, the package 90 is kneaded to mix the components. Then, the package 90 or the contents of the package 90 may be inserted/emptied into the cylinder 38. Last, the cylinder 38 is threaded to the cap 36 and the system is ready for use. In prior art treatments, the treatment formulation may become too old for use after thirty minutes, whereas, the present system with the formulation enclosed in the storage compartment 30, allows the treatment formulation to remain fresh for longer periods of time. The package 90 may be made of baby bottle liner bags which will reduce landfill waste when compared to the chemical containers currently used by hairdressers/technicians.

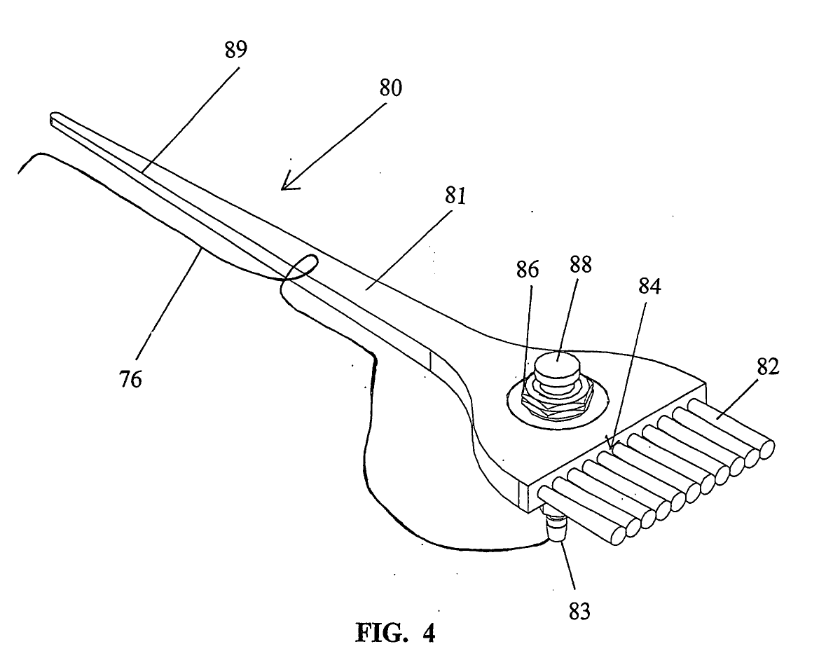

Referring to FIG. 4, the applicator 80 may in one embodiment comprise a brush 81 with bristles 82. The brush 81 has a barb fitting 83. Tube 76 connects the entraining device 10 to the barb fitting 83. The brush 81 has an internal passageway from the barb fitting 83 to an outlet 84. The tube 76 feeds the treatment composition (mix of pressurized air and treatment formulation) into the brush 81 where it exits from outlet 84 and flows onto bristles 82. The forty-five psi introduction of the composition onto the bristles allows an even and steady flow of a typically thick, viscous hair treatment formulation onto the bristles 82. The technician can hold the handle 89 of the brush 81 and apply the treatment formulation to the hair of a customer while receiving an automatic, steady flow of the formulation onto the bristles 82. A valve 86 with a push-button activator 88 may be mounted on the brush 81 and into the passageway for selectively opening, adjusting the amount of the opening or closing the passageway. In this manner, the technician can complete the typical application of a hair treatment composition in about five to twelve minutes, followed by thirty minutes of post application processing of the customer. Clean-up including running saline into the storage compartment 30 may be completed in approximately one minute. This allows the hairdresser/technician to perform more hair treatments daily, and customers save fifteen to twenty minutes of appointment time.

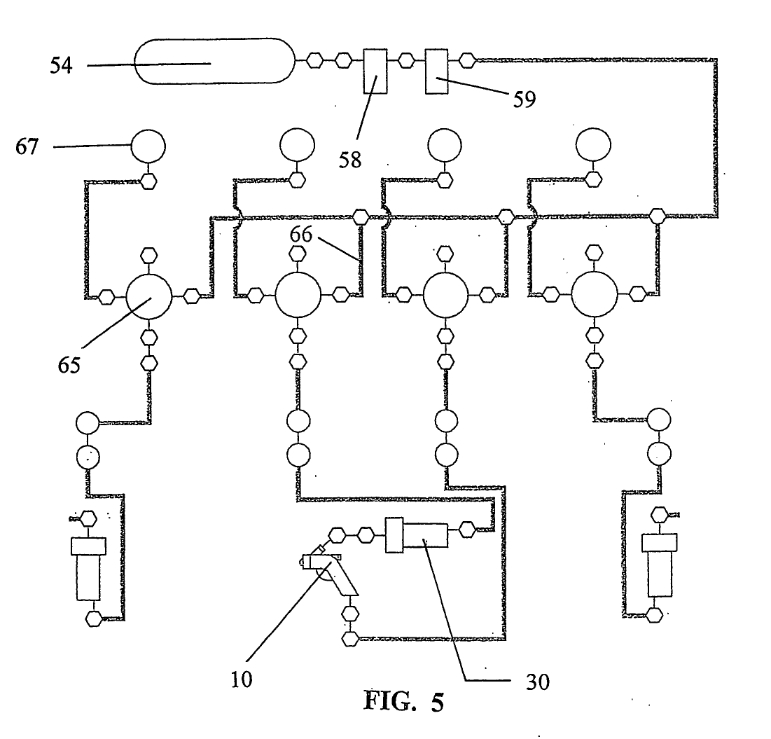

FIG. 5 shows a pneumatic diagram for the embodiment of the invention previously described.

It is to be understood that the entraining device 10 and the storage chamber 30 could be force fed by some other type of device, such as, for example, gravity feed (not shown).

The invention(s) have been described in embodiments for applying color, tint, highlights, conditioners, relaxers and oils to the hair, but may be used for other purposes, such as, by way of example, for applying tanning agents, spa treatments or for applying various compositions to other mammals.

In conclusion, therefore, it is seen that the present invention(s) and the embodiment(s) disclosed herein are well adapted to carry out the objectives and obtain the ends set forth. Certain changes can be made in the subject matter without departing from the spirit and the scope of this invention. It is realized that changes are possible within the scope of this invention and it is further intended that each element or step recited is to be understood as referring to all equivalent elements or steps. The description is intended to cover the invention as broadly as legally possible in whatever forms it may be utilized.

What is claimed is:

1. An apparatus for applying a composition to a physical structure on a mammal, comprising:
a entraining device;
a storage chamber for the composition, wherein the storage chamber is connected to the entraining device;
an applicator for applying the composition, wherein the applicator is connected to the entraining device; and
a force feeding device connected to the entraining device.

2. The apparatus according to claim 1, wherein the entraining device is a paint gun.

3. The apparatus according to claim 1, wherein the entraining device includes a handle, a valve, a lever connected to the valve and to the handle, and a mixing chamber connected to the valve.

4. The apparatus according to claim 1, wherein the storage chamber includes a pouch having a volume of a hair treatment formulation and a volume of an activator for the hair treatment formulation.

5. The apparatus according to claim 1, wherein the storage chamber includes a cylinder, a cap attaching to the cylinder, a plunger mounted in the cylinder, a rod connected to the plunger and extending through an opening in the storage chamber, a handle connected to the rod, a gas/fluid inlet connected to the force feeding device, and an outlet connected to the entraining device.

6. The apparatus according to claim 5, wherein the outlet of the storage chamber is connected to an elbow shaped fitting which is mounted on the entraining device.

7. The apparatus according to claim 1, wherein the applicator comprises a spray nozzle.

8. The apparatus according to claim 1, wherein the applicator comprises a brush.

9. The apparatus according to claim 8, wherein the brush is connected to the entraining device by a flexible tube.

10. The apparatus according to claim 9, wherein the brush has internal passageway connected at one end to the flexible tube and at another end has an exit opening proximate a plurality of bristles, wherein the plurality of bristles are attached to the brush.

11. The apparatus according to claim 10, further including a valve mounted in the passageway for selectively opening and closing the passageway.

12. The apparatus according to claim 1, wherein the force feeding device comprises a source of pressurized air.

13. The apparatus according to claim 12, wherein the source of pressurized air comprises a compressor.

14. The apparatus according to claim 13, wherein the compressor is connected to a motor, and wherein the compressor and the motor are mounted inside an enclosure.

15. The apparatus according to claim 14, wherein the enclosure has a vent.

16. The apparatus according to claim 15, wherein the vent includes a fan and a filter mounted on the enclosure.

17. The apparatus according to claim 14, wherein the enclosure includes a regulator connected to the compressor on one end and on another end being connected to the entraining device.

18. The apparatus according to claim 14, wherein the enclosure includes a regulator connected to the compressor on one end and on another end being connected to the gas/fluid inlet to the storage chamber.

19. The apparatus according to claim 18, further including a gauge mounted on the enclosure and connected to the regulator.

20. An apparatus for applying a composition to a physical structure of a mammal, comprising:
a entraining device wherein the entraining device includes a handle, a valve, a lever connected to the valve and to the handle, a mixing chamber connected to the valve and a storage chamber wherein the storage chamber includes a cylinder, a cap attaching to the cylinder, a plunger mounted in the cylinder, a rod connected to the plunger and extending through an opening in the storage chamber, a handle connected to the rod, a gas/fluid inlet connected to the force feeding device, and an outlet connected to the entraining device.

21. An apparatus for applying a composition to a physical structure of a mammal, comprising a brush wherein the brush has internal passageway connected at one end to the flexible tube and at another end has an exit opening proximate a plurality of bristles, wherein the plurality of bristles are attached to the brush.

22. The apparatus according to claim 21, further including a valve mounted in the passageway for selectively opening and closing the passageway

23. An apparatus for supplying pressurized air to a device to be activated by the pressurized air, comprising:
an enclosure;
a compressor;
a motor, wherein the compressor is connected to the motor, and wherein the compressor and the motor are mounted inside the enclosure
wherein the enclosure has a vent including a fan and a filter mounted on the enclosure; and
wherein the enclosure includes a regulator connected to the compressor on one end and on another end being connected to the device to be activated.

24. A package for holding a hair treatment formulation, comprising:
a first sealed pouch containing a volume of a hair treatment formulation;
a second sealed pouch containing a volume of an activator for the hair treatment formulation, wherein the second sealed pouch is connected by a conduit to the first sealed pouch; and
a third sealed pouch containing both the first sealed pouch and the second sealed pouch.

25. A method for applying a composition to a physical structure on a mammal, comprising the steps of:
pressurizing a supply of the composition;
entraining the composition into a stream of pressurized air;
applying a mixture of the composition and the pressurized air to the physical structure on the mammal.

26. The method according to claim 25, further including the step of moving the mixture of the composition and the pressurized air through a flow line performed prior to said step of applying the mixture.

27. The method according to claim 25 wherein said applying step comprises brushing the composition onto the physical structure of the mammal.

28. The method according to claim 27 wherein the physical structure of the mammal is a plurality of hairs on a human's head.

29. The method according to claim 28, wherein said moving step is performed at a pressure of around forty-five psi.
